(19) United States
(12) Patent Application Publication
(10) Pub. No.: US 2026/0280973 A1
(43) Pub. Date: Sep. 17, 2026

(54) IDENTIFYING A POINT OF FAILURE IN A FIRST NETWORK USING A SECOND NETWORK

(71) Applicant: SIGNIFY HOLDING B.V., EINDHOVEN (NL)

(72) Inventor: XIAOBO JIANG, SHANGHAI (CN)

(21) Appl. No.: 19/470,890

(22) PCT Filed: Mar. 28, 2024
(86) PCT No.: PCT/EP2024/058537

§ 371 Date: Sep. 30, 2025

(30) Foreign Application Priority Data
Apr. 4, 2023 (WO) PCT/CN2023/086274
May 30, 2023 (EP) 23176130.5

(51) Int. Cl. H04L 41/0677; H04L 41/12

(52) U.S. Cl. CPC H04L 41/0677; H04L 41/12

(57) ABSTRACT

A method of identifying a point of failure in a first network via a second network, wherein the first network comprises first type devices (350-351), wherein the first type devices are communicatively connected to a first management system (310) via one of the first type devices, wherein the second network comprises second type devices (360-361) each communicatively connected to a second management system (311), and wherein a first device of the first type devices and a second device of the second type devices are located at a same location, the method comprising: the first device generating a neighbor list comprising an indication of active communicatively connected other first type devices; transmitting the neighbor list from the first device to the first management system via the second device and the second management system; and the first management system determining the point of failure based on the neighbor list.

### TECHNICAL FIELD

The present disclosure relates to identifying points of failure in data communication networks. More specifically, the present disclosure relates to a method of identifying a point of failure in a network, and a device and a network using said method.

### BACKGROUND

Data networks are typically monitored to identify points of failure, e.g., by detecting network nodes or network links going offline. Such monitoring may be performed from a cloud-based management system that periodically polls the status of network nodes and network links in a data network.

Detection of a point of failure is usually followed up by a network maintenance task to solve the problem. This can involve a remote, e.g., software-based maintenance, or a local maintenance requiring a person to go to the location of the detected failure. Especially in the latter case, false alarms are to be avoided to avoid unnecessary maintenance tasks to be deployed.

Some network topologies are more prone to false detection of failures. An example of such network is a Terragraph™ network, which includes individual nodes supported by network services operating in the cloud. Due to Terragraph™ network's tree topology, if one node or link is down, the sibling nodes and/or links will not be reachable by the cloud, and all of these links and nodes may be incorrectly marked as being down.

EP 3883347A1 relates to a road lighting management system which controls the lamps and manages the assets through the smart lighting management cloud platform and the mobile terminal.

EP 3120069A1 partially automated commissioning of a lighting device at installation. The local control module determines the location of the lighting device using the positioning module, and transmits commissioning information to a register of a lighting management system by transmitting the commissioning information over the pre-existing public wireless network via the wireless interface.

WO 0150266A1 relates to a method of monitoring a network including a plurality of components comprises providing a monitoring request to a component for monitoring the network for an apparent failure of the component on the network and immediately monitoring availability of a chain of components between a failed component and a monitoring system to establish which component in the chain is causing the apparent failure in subsequent components.

US2013051279A1 relates to a method of managing resources to allow networks or devices coexist.

There is a need for a solution to detect whether detected points of failure are actual points of failure, in particular in network topologies where sibling network nodes are connected to a cloud-based management system via one node, e.g., hub node.

### SUMMARY

A summary of aspects of certain examples disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects and/or a combination of aspects that may not be set forth.

The present disclosure aims to overcome the drawbacks identified in the background section. In particular, the present disclosure aims to identify actual points of failure in a first network using a second network, when devices in the first network are, possibly falsely, detected as being offline.

According to an aspect of the present disclosure, a method of identifying a point of failure in a first network via a second network is presented. The first network may include a plurality of first type devices. The plurality of first type devices may be communicatively connected to a first management system via one of the first type devices. The second network may include a plurality of second type devices each communicatively connected to a second management system. A first device of the first type devices and a second device of the second type devices may be located at a same location. The method may include generating, by the first device, a neighbor list. The neighbor list may include an indication of one or more other first type devices that are actively communicatively connected to the first device. The method may further include transmitting the neighbor list from the first device to the second device. The method may further include transmitting the neighbor list from the second device to the second management system. The method may further include transmitting the neighbor list from the second management system to the first management system. The method may further include determining, by the first management system, the point of failure based on the neighbor list.

In an embodiment, the method may further include, prior to generating the neighbor list: detecting, by the first management system, an offline first type device among the plurality of first type devices; obtaining, by the first management system, a location of the offline first type device; determining, by the second management system, the second device based on the location of the offline first type device; and requesting, by the second management system, the neighbor list from the first device via the second device.

In an alternative embodiment, the method may further include, prior to generating the neighbor list: detecting, by the first device, a disconnection from the one of the first type devices to trigger the generating of the neighbor list.

In an embodiment, the determining, by the first management system, of the point of failure may include: comparing the other first type devices indicated in the neighbor list with detected offline first type devices to determine if and which first type devices and/or links between first type devices are the point of failure.

In an embodiment, the neighbor list comprises one or more of: an identification of the first device; an identification of each of the other first type devices; an indication of a number of active links between the first device and the other first type devices.

In an embodiment, the second device may add one or more of the following data to the neighbor list: a message type indicative of being a neighbor list; geographical location data indicative of said same location.

In an embodiment, the first device and a second device may be parts of one device or node.

In an embodiment, the one device or node may be a broadband luminaire device.

In an embodiment, the first network may be a tree structure-based network, such as a Terragraph™-based data communication network.

In an embodiment, the second network may include communicatively connected luminaires, such as smart luminaires.

In an embodiment, the first management system and the second management system may be implemented as cloud services, possibly as a combined, integrated or single management system.

In an embodiment, the point of failure may be one or more of: an offline link between two first type devices; an offline first type device.

According to an aspect of the present disclosure, a device is proposed. The device may include a first device of a first type and a second device of a second type. The first device may be part of a first network. The first device may be configured to be communicatively connected to a first management system. The first device may be communicatively connected one or more other first type devices. The second device may be part of a second network. The second device may be configured to be communicatively connected to a second management system. The first device and the second device may be communicatively connected via a communication link. The first device may be configured to generate a neighbor list. The neighbor list may include an indication of one or more other first type devices that are actively communicatively connected to the first device. The first device may be configured to transmit the neighbor list to the second device. The second device may be configured to transmit the neighbor list to the second management system to enable the first management system to determine a point of failure in the in the first network based on the neighbor list transmitted to the second management system.

According to an aspect of the present disclosure, a network is proposed. The network may include a plurality of first type devices. The plurality of first type devices may be communicatively connected to a first management system via at least one of the first type devices. The network may further include a plurality of second type devices each communicatively connected to a second management system. A first device of the first type devices and a second device of the second type devices may be parts of one device or node. The first device may be configured to generate a neighbor list. The neighbor list may include an indication of one or more other first type devices that are actively communicatively connected to the first device. The first device may be configured to transmit the neighbor list to the second device. The second device may be configured to transmit the neighbor list to the second management system. The second management system may be configured to transmit the neighbor list to the first management system. The first management system may be configured to determine a point of failure in the first network based on the neighbor list.

In an embodiment, the first communication network may be a tree structure-based network, such as a Terragraph™-based data communication network. The second communication network may include communicatively connected luminaires, such as smart luminaires.

### BRIEF DESCRIPTION OF THE DRAWINGS

Embodiments of the present disclosure will now be described, by way of example only, with reference to the accompanying schematic drawings in which corresponding reference symbol indicate corresponding parts, in which:

FIG. 1 shows an example prior art tree topology-based network architecture;

FIG. 2 shows an example network architecture of an example embodiment;

FIG. 3 shows a part of a network architecture of an example embodiment in more detail;

FIG. 4 shows two overlapping networks of different types;

FIG. 5 shows a time-sequence diagram of an example embodiment;

FIG. 6 shows a time-sequence diagram of another example embodiment; and

FIG. 7 shows an example computer system.

The figures are intended for illustrative purposes only, and do not serve as restriction of the scope of the protection as laid down by the claims.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the present disclosure is, therefore, indicated by the appended claims. All changes which come within the meaning and range of equivalency of the claims are to be embraced within their scope.

Reference throughout this specification to features, advantages, or similar language does not imply that all of the features and advantages that may be realized with the present disclosure should be or are in any single example of the present disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same example.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure. Reference throughout this specification to “one embodiment,” “an embodiment,” or similar language means that a particular feature, structure, or characteristic described in connection with the indicated embodiment is included in at least one embodiment of the present disclosure. Thus, the phrases “in one embodiment,” “in an embodiment,” and similar language throughout this specification may, but do not necessarily, all refer to the same embodiment.

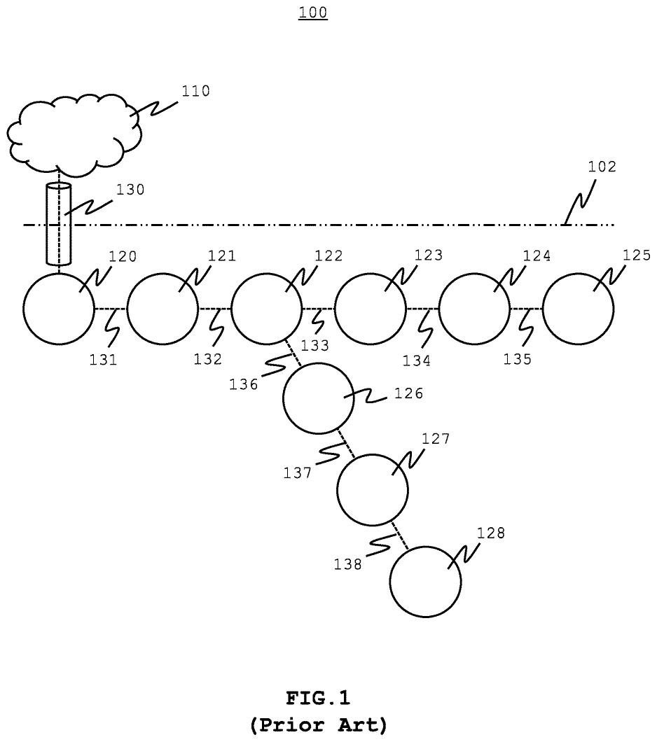

Network nodes and links may be monitored to detect failures in a network. The detection of a point of failure enables precise maintenance at the node or link where the failure occurs. The detection of points of failure can be difficult when nodes or links cannot be reached because of another point of failure. For example, in a tree structure-based network architecture, such as shown in FIG. 1, there are several scenarios where false detection of failures can occur.

FIG. 1 shows an example of a tree structure-based network architecture 100, in this example for a Terragraph™ data network. The line 102 indicates a division between a control plane of the network architecture, i.e., the part above the line 102, and a user plane of the network architecture, i.e., the part below the line 102. The user plane of the Terragraph™ data network includes a number of nodes 120-128, which are managed by a network management system (NMS) 110. The NMS 110 may be implemented as a cloud backend service. One of the nodes typically operates as a hub node 120 for connecting the nodes 120-128 to the NMS 110. The nodes 120-128 are interconnected by links 131-138. It will be understood that the number of nodes and the tree structure of the network can be different from the example of FIG. 1; FIG. 1 is a mere example.

In the Terragraph™ network of FIG. 1, the links 131-138 are typically broadband wireless links, e.g., based on mmWave, 4G-based data communication or 5G-based data communication. In other network architectures, the nodes 120-128 may be interconnected using other suitable wired or wireless communication technologies. The connection between hub node 120 and the NMS 110 may be implemented as a virtual private network (VPN) tunnel 130, typically over a fiber connection or any other suitable high-bandwidth connection.

Each of the nodes 120-128 may include a radio device for communication, via respective links 131-138, to another node 120-128. In the example of FIG. 1, node 120 is communicatively connected to node 121 via link 131, node 121 is communicatively connected to node 122 via link 132, node 122 is communicatively connected to nodes 123 and 126 via links 133 and 136, respectively, node 123 is communicatively connected to node 124 via link 134, node 124 is communicatively connected to node 125 via link 135, node 126 is communicatively connected to node 127 via link 137, and node 127 is communicatively connected to node 128 via link 138. In this example, no other communication links are possible between the nodes.

The NMS 110 is typically configured to raise an alarm if, e.g., any of the nodes 120-128 or any radio device of the nodes 120-128 is not functioning, or a mmWave link 131-138 is down. Those alarms indicate that the broadband network is not in good service, and maintenance is required immediately.

However, due to the tree network topology and system architecture, the offline determination may not be accurate. False alarms may be triggered, e.g., when the VPN tunnel 130 is down or when nodes appear offline due to a parent node in the tree being offline.

In the example of FIG. 1, in order to poll the status of, e.g., node 122, the NMS 110 needs to reach to local network via the VPN tunnel 130, and then the communication is relayed by hub node 120 to node 121 and then to node 122. If node 122 is no longer pollable, then the NMS 110 may identify node 122 as being offline and may create an alarm to trigger maintenance.

Due to the characteristics of the network in FIG. 1, communication from the NMS 110 to the onsite radio devices of the nodes 120-128 relies on one VPN communication channel 130. Moreover, due to the tree topology, if a parent node is down, all sibling nodes will be out of reach from the NMS 110, even if the orphan network is still online and operational.

In a first scenario, VPN tunnel 130 may be down, causing all node 120-128 and links 131-138 to be unreachable and unpollable from the NMS 110. The NMS 110 may therefore wrongly mark all of nodes 120-128 and/or links 131-138 as being offline, while in reality only the VPN tunnel 130 is down.

In a second scenario, one link, e.g., link 133, may be down, causing all sibling nodes 123-125 and sibling links 134-135 not being reachable or pollable from the NMS 110. The NMS 110 may therefore wrongly mark all of nodes 123-125 and/or links 133-135 as being offline, while in reality only link 133 is down. A link 131-138 may go down because of, e.g., mmWave line of sight being blocked, a wrong configuration or a bad radio signal.

In a third scenario, one node, e.g., node 123, may be down, causing all sibling nodes 124-25 and sibling links 134-135 not being reachable or pollable from the NMS 110. The NMS 110 may therefore wrongly mark all of nodes 123-125 and/or links 133-135 as being offline, while in reality only node 123 is down.

To overcome the problem of false detection of points of failure in nodes and/or links of a data network, such as described in conjunction with the tree structure-based network of FIG. 1, the present disclosure presents the use of another data network to more accurately detect the point of failure in the data network. Hereinafter, the data network, such as the tree structure based network of FIG. 1, where false detection of failures may occur, is referred to as “first network” and the other data network that is used to more accurately detect the point of failure in the first network, is referred to as “second network”.

The first network is typically different from the second network. This difference may be characterized by the use of different communication techniques and/or different network topologies.

For example, the first and second network may use different types of radio devices utilizing different types of radio communication and/or different communication protocols. An example of a first network is the Terragraph™ network of FIG. 1, where the nodes 120-128 are first type devices, e.g., based on mm Wave broadband radio devices. An example of a second network is a short-range data network, where nodes are second type devices, e.g., based on Long Term Evolution (LTE), ZigBee™, Bluetooth™, or any other suitable data communication technology. The present disclosure is not limited to these types of first devices and second devices. Any radio technology may be used for the first type devices and the second type devices, where the first type devices and the second type devices form separate networks.

The first and second network are typically based on different network topologies. The first network may have a tree structure, such as shown in FIG. 1. Preferably, the second network does not have a tree structure, i.e., the nodes in the second network do not have parent/sibling dependencies as in a tree structure-based network topology where multiple nodes and/or links can become unreachable by one node or link being unreachable. An example of a second network is a LTE-based network, where all nodes (i.e., with second type devices being LTE devices) form, e.g., a star or mesh topology where multiple nodes connect to one management system. The present disclosure is not limited to these first and second network topologies. Any other network topologies may be used for the first and second network, respectively, wherein, preferably, nodes of the second network can be reached by a management system directly, i.e., without an intermediate node.

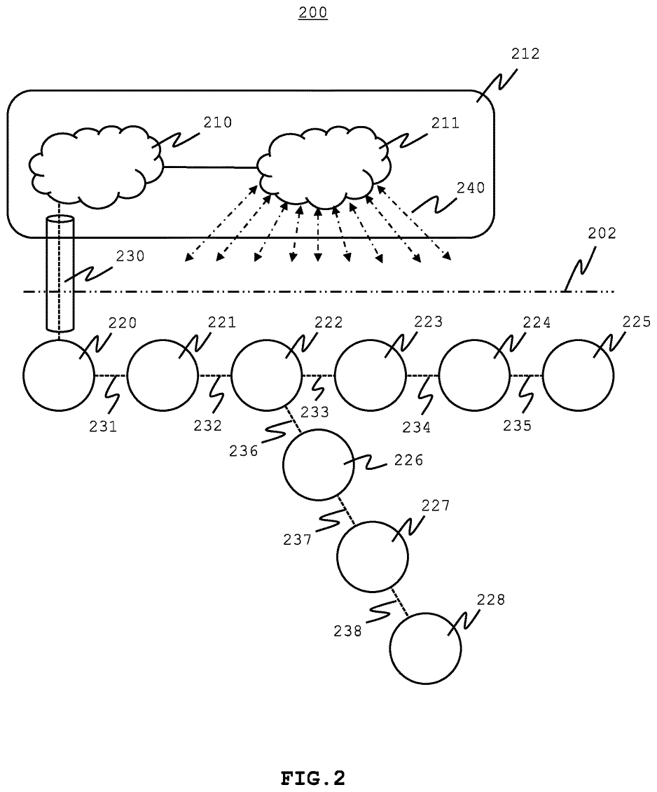

FIG. 2 shows an example embodiment of the present disclosure, wherein a network architecture 200 includes a first network that is managed by a first management system 210 and a second network that is managed by a second management system 211. The first management system 210 and the second management system 211 may be communicatively connected. The first management system 210 and the second management system 211 may be integrated in a combined management system 212. The first management system 210, the second management system 211 and/or the combined management system 212 may be implemented as cloud-based systems. The line 202 indicates a division between a control plane of the network architecture, i.e., the part above the line 202, and a user plane of the network architecture, i.e., the part below the line 202.

In the example of FIG. 2, each of the nodes 220-228 includes two radio devices, one for the first network and one for the second network, allowing the two networks to operate independently albeit using the same nodes. In the present disclosure, nodes 220-228 may also be referred to as devices 220-228. A node 220-228 may include a first type device, e.g., a mm Wave radio device for broadband communication on the first network managed by the first management system 210, and the node 220-228 may further include a second type device for other communication, e.g., LTE, Zigbee™ or Bluetooth™ communication on the second network managed by the second management system 211. The two networks are typically used for different functions of the node 220-228. For example, a node 220-228 may be an Internet-of-Things (IoT) device that provides broadband data communication to connected devices via the first network, while being integrated with a smart luminaire device that can be controlled via the second network.

The first network may be a tree structure-based network, in the example of FIG. 2 including radio devices in nodes 220-228 and links 231-238, e.g., similar to the nodes 120-128 and links 131-138 of FIG. 1. In the first network, node 220 may operate as a hub node 220 to connect the radio devices of nodes 220-228 of the first network (i.e., the first type devices) to the first management system 210 via data connection 230, e.g., similar to hub node 120, NMS 110 and VPN connection 130 of FIG. 1.

The second network may be a star-shaped and/or mesh network, where multiple nodes can communicate directly with the second management system 211 via communication channels 240 and radio devices of nodes 220-229 of the second network (i.e., the second type devices). In the example of FIG. 2, each node 220-228 can communicate directly with the second management system 211 via a second type device and one of the communication channels 240.

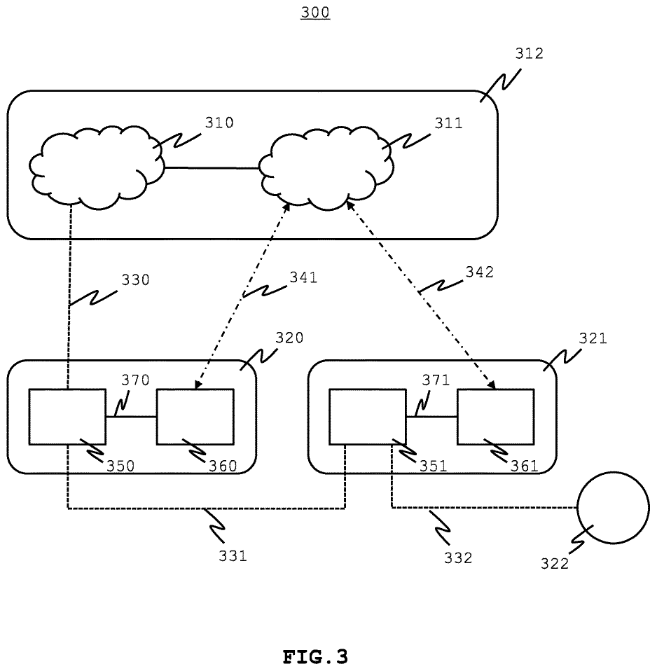

FIG. 3 shows a part 300 of the network architecture 200. First management system 310 and second management system 311 correspond to the first management system 210 and the second management system 211 of FIG. 2. The first management system 310 and the second management system may be integrated in a combined management system 312, similar to combined management system 212. Three nodes 320-322 are shown, which correspond to nodes 220-222 of FIG. 2. The other nodes of FIG. 2 are not shown in FIG. 3 for simplicity. Link 330 corresponds to data connection 230 of FIG. 2. Links 331 and 332 correspond to links 231 and 232 of FIG. 2. Links 341 and 342 are two of the communication channels 240 of FIG. 2.

As shown in FIG. 3, a node 320, 321 may include a first device 350, 351 of a first type and a second device 360, 361 of a second type. Each of the nodes 220-228 of FIG. 2 may be configured accordingly. The first device 350, 351 and the second device 360, 361 correspond to the first device and second type device as described in the example of FIG. 2.

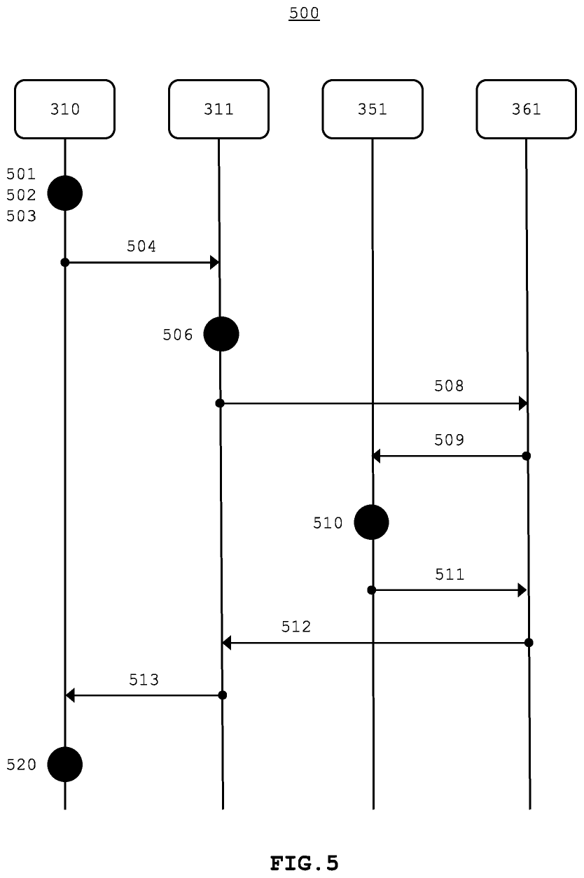

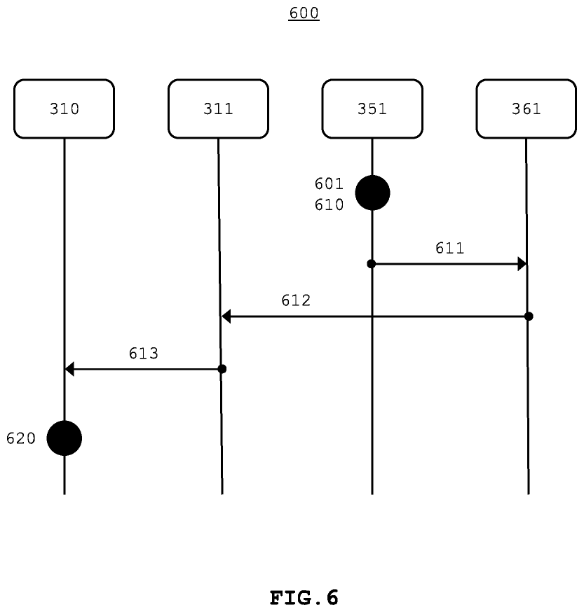

The first device 350, 351 may be communicatively connected to the second device 360, 361 via a communication link 370, 371. This communication link 370, 371 is typically used for intra-node communication and not for inter nodes data communication. The communication link 370, 371 enables identification of a point of failure in the first network via the second network, as will be further discussed in the examples of FIG. 5 and FIG. 6

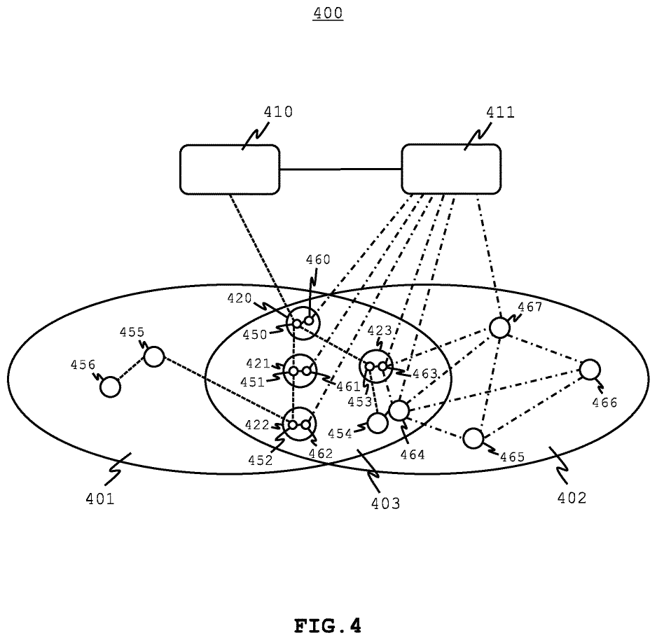

In the examples of FIG. 2 and FIG. 3, the first type devices 350, 351 in the first network and the second type devices 360, 361 in the second network are integrated in a node 320, 321. Other network configurations are possible, as shown in the example network architecture 400 of FIG. 4. FIG. 4 shows a first network 401 and a second network 402. The first network 401 includes first type devices 450-456 that are communicatively connected, similar to the first type devices 350-351 of FIG. 3. The first network 401 may be managed by first management system 410, similar to first management system 310. The second network 402 includes second type devices 460-467 that are communicatively connected to second management system 411, similar to the second type devices 360-361 of FIG. 3.

The first network 401 may be a tree structure-based network or any other type of network including first type devices 450-454 for which a point of failure may be verified using the second network 402. The second network 402 includes second type devices 460-464 that are located at a same location of first type devices 450-454 to enable the second type devices 460-464 to support the first network 401 in determining the point of failure.

A first device of the first type and a second device of the second type are defined to be located at the same location when the two devices are, e.g., part of one node, such as shown in FIG. 3 for first device 350 and second device 360 being part of node 320. In FIG. 4 nodes 420-423 are shown to include a first type device 450-453 and a second device 460-463. The first device 450-453 and the second device 460-463 are communicatively connected, as shown in FIG. 3 by communication link 370, 371. Being located at the same location may also be defined as being located at substantially the same geographical location while not being part of one node, such as shown for first type device 454 and second type device 464 in FIG. 4. Also, these first type device 454 and second type device 464 may be communicatively connected to enable the second type device 464 to assist in the determination of a point of failure in the first network 401, in this case through the first type device 454. The first device 454 and the second device 464 may be located different locations, as long as the geographical location of the first type device 454 can be used to find a second type device 464 that is communicatively connected to the first type device 454.

As shown in FIG. 4, the first network 401 may include first type devices 455, 456 that are not located at a same location as a second type device 460-467. For these first type devices 455, 456 a point of failure cannot be verified using the second network 402.

Similarly, the second network 402 may include second type devices 465-467 that are not located at a same location as a first type device 450-456. These second type devices 465-467 cannot be used to support the first network in verifying a point of failure.

In FIG. 4, the overlap 403 between the fist network 401 and the second network 402 indicates all first type devices 450-454 that are communicatively connected to a second type device 460-464 and for which the second network 402 can support the first network 401 in determining points of failures.

Second type devices 460-464 that can be used in supporting the identification of points of failures in the first network 401 are preferably directly connected to second management system 411 via a point-to-point communication link, such as shown in FIG. 4 for second type devices 460-464. The second network 402 may include second type devices that connected differently. In the example of FIG. 4 second type devices 460-464 and 467 are directly connected to the second management system 411 and second type devices 463-467 also form a mesh network. It will be understood that other network topologies may be formed by the second type devices 460-467.

FIG. 5 shows an example time-sequence diagram 500 of a method of identifying a point of failure in a first network, such as first network 401 of FIG. 4, via a second network, such as second network 402 of FIG. 4. The elements involved in the process are shown as first management system 310, second management system 311, first device 351 of a first type and second device 361 of a second type, corresponding to the respective elements of FIG. 3. It will be understood that the process may be the same for first management system 410, second management system 411, any of the first type devices 450-454 and any of the second type devices 460-464 of FIG. 4.

In the example of FIG. 5, the first type device may be a mm Wave radio device, such as used in a Terragraph™-based network, and the second type device may be a smart luminaire device using LTE communication. In the example of FIG. 5, the first management system 310 may be an NMS and the second management system may be a LTE-based luminaire control system. It will be understood that the present disclosure is not limited to this example and that other network types and other network devices may be used.

In the example of FIG. 5, when applied to the example of FIG. 3, the actual point of failure may be at first type device 350, causing first type device 351 to be detected as offline as well, because first type device 351 cannot reach the first management system 310 anymore. The present disclosure enables the point of failure to be identified at the first type device 350. In the following, the one of the first type devices that is falsely detected as being a point of failure will be referred to as first device 351.

In step 501, the first management system 310 may detect that the first device 351 and/or a link adjacent to this first device 351 becomes offline. Because of the network topology, a point of failure at first device 351 may thus be falsely identified. It is possible that one or multiple first type devices and/or links are detected to be offline. Detection 501 may trigger use of the second network 402 for more accurate identification of the point of failure in the first network 401.

The detection 501 may be conditionally. For example, it may be detected that a first type device and a link adjacent to this first device become offline at substantially the same time. Alternatively or additionally, it may be detected that two or more first type devices and/or links become offline. Alternatively or additionally, it may be detected that first type radio devices and/or links in a same network branch (i.e., including sibling nodes of the first device 350) of the first network become offline.

In step 502, the first management system 310 may collect location information, e.g., in the form of Global Positioning System (GPS) location information or node identification information, of the detected offline first device 351. Hereto, a database, memory or other data storage may be queried where first type devices and their locations are stored.

In step 503, the first management system 310 may generate a device list including the locations of detected offline first devices, including the detected offline first device 351 and possibly other detected offline first type devices. In step 504 this device list may be transmitted to the second management system 311.

Based on the location information in the device list, in step 506 the second management system 311 may determine second type devices located at a same location. Hereto, a database, memory or other data storage may be queried where smart luminaire devices and their locations are stored. In this example, the second device 361 may thus be determined.

In step 508, query data packages may be transmitted, using the second network 402, to the second type devices determined in step 506, including the second device 361.

In step 509, the second device 361 may send the query data packet, e.g., via communication link 371, to the first device 351 at the same location.

In step 510, the first device 351 may query itself, may find all active links, and/or may find those link's remote device name, and compose a neighbor list message including an indication of other first type devices that are actively communicatively connected to this first device 351.

In step 511, the first device 351 may send the neighbor list to the second device 361, in step 512 the second device 361 may send the neighbor list to the second management system 311, and in step 513 the second management system 311 may send the neighbor list to the first management system 310.

In step 520, the first management system 310 may determine the actual points of failure based on the received neighbor list. In this example, it may thus be determined that the first device 351 was falsely detected to be a point of failure and that first type device 350 is the point of failure. Thus, one or multiple points of failure may be detected in the first network by using the second network.

FIG. 6 shows another example of a time-sequence diagram 600 of a method of identifying a point of failure in a first network, such as first network 401 of FIG. 4, via a second network, such as second network 402 of FIG. 4. Similar to the example of FIG. 5, in FIG. 6 the elements involved in the process are shown as first management system 310, second management system 311, first device 351 of a first type and second device 361 of a second type, corresponding to the respective elements of FIG. 3. It will be understood that the process may be the same for first management system 410, second management system 411, any of the first type devices 450-454 and any of the second type devices 460-464 of FIG. 4.

In the example of FIG. 6, when applied to the example of FIG. 3, the actual point of failure may be at first type device 350, causing first type device 351 to be offline as well. The present disclosure enables the actual point of failure to be identified at the first type device 350. In the following, the one of the first type devices that is falsely detected as being a point of failure will be referred to as first device 351.

In step 601, the first device 351 may detect that it becomes offline. For example, the first device 351 may periodically ping the hub node 220, the first management system 310 or a network location external to the first network 401, e.g., an Internet address, to determine its online status. Because of the network topology of the first network 401, the first management system 310 may falsely determine the first device 351 to be a point of failure, because the first device 351 cannot be reached. Detection 601 may trigger use of the second network 402 for more accurate identification of the point of failure in the first network 401.

In step 610, the first device 351 may query itself, may find all active links, and/or may find those link's remote device name, and compose a neighbor list message including an indication of active first type devices that are actively communicatively connected to this first device 351.

In step 611, the first device 351 may send the neighbor list to the second device 361, in step 612 the second device 361 may send the neighbor list to the second management system 311, and in step 613 the second management system 311 may send the neighbor list to the first management system 310.

In step 620, the first management system 310 may determine the actual points of failure based on the received neighbor list. In this example, it may thus be determined that the first device 351 was falsely detected to be a point of failure and that first type device 350 is the point of failure. Thus, one or multiple points of failure may be detected in the first network by using the second network.

In an embodiment, the neighbor list transmitted from the first device 351 to the second device 361, e.g., in step 511 or step 611, may include one or more of the following data fields: a device name of the first device; a number of active links to neighboring first type devices; and/or a list of active link's neighborhood first type device names. The size of the neighbor list may be minimized by only including a list of active link peer's device names.

In an embodiment, the second device 361 may add information to the neighbor list, such that the neighbor list transmitted from the second device 361 to the second management system 311, e.g., in step 512 or step 612, may further include one or more of the following data fields: a message type indicative of being a neighbor list; and/or location information of the second device 361, e.g., in the form of GPS data or a node identifier. The size of the neighbor list may be minimized by only including the list of active peer's device names, and the message type allowing the second management system 311 to recognize the received data as neighbor list.

In an embodiment, the second management system 311 may modify the neighbor list, such that the neighbor list transmitted from the second management system 311 to the first management system 310, e.g., in step 513 or step 613, may include one or more of the following data fields: location information, e.g., in the form of GPS data or a node identifier; a device name of the first device; a number of active links to neighboring first type devices; and/or a list of active link's neighborhood first type device names.

The data size of the neighbor list may be reduced by not including the name of the first device 351 and have the first management system 310 and/or second management system 311 determine the first device 351 based on the location information of the second device as received in the neighbor list and correlating this location information with known locations of the first type devices. Moreover, the number of active wireless links as seen by the first device 351 may be calculated from the length of a link neighbor list included in the neighbor list.

In an embodiment, the first management system 310 may use the received neighbor list to cross check the location information and the device name of the first device and find the corresponding first type device in the first network. The first management system 310 may compare the reported number of active links with an expected number of active links. If this number is equal, it may be concluded that this first type device and adjacent links are operational, i.e., are not a point of failure. Thus, even if the first device is determined to be offline, e.g., because it is not pollable from the first management system 310, the first management system 310, may determine that the first device is not a point of failure. If this number is not equal, then the neighbor device names in the neighbor list may be compared with a list of expected neighbor devices known to the first management system 310. The first management system 310 may thus determine first type devices missing in the neighbor list and conclude that these missing first type devices are points of failure in the first network.

Thus, any of the scenarios of false detection as described in conjunction with FIG. 1 can be corrected and actual points of failure in the first network may be determined.

In an embodiment, the nodes 220-228, 320-322, 420-423 may be broadband luminaire devices, wherein the first type devices form a data network, e.g., a mmWave broadband network, 4G data network, 5G data network, or any other suitable data network, e.g., forming a Terragraph™ network, and wherein the second type devices form a smart luminaire network, e.g., based on LTE, Zigbee™ or Bluetooth™ data communication.

In an embodiment, the communication link 370-371 between the first device 350-351, 450-454 and the second device 360-361, 460-464 may be wired, e.g., based on Digital Addressable Lighting Interface (DALI™), or wireless, e.g., based on Bluetooth™. A packet sent on this communication link 370, 371 may be small in size and specially designed for the purpose of the present disclosure.

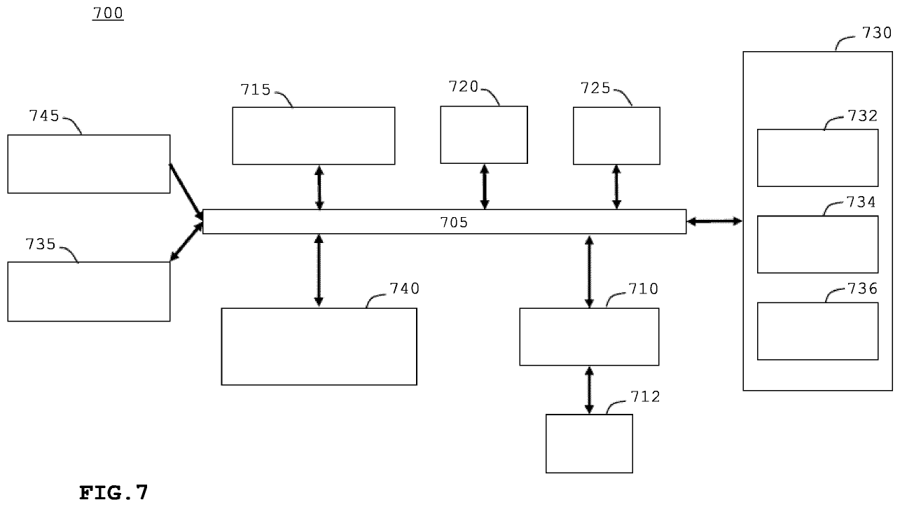

FIG. 7 shows an example embodiment of a computing system 700 for implementing certain aspects of the present technology. In various examples, the computing system 700 can be any computing device making up the first management system 210, 310, 410, the second management system 211, 311, 411, the combined management system 212, 312, the devices/nodes 220-228, 320-321, 420-423, the first type devices 350-351, 450-456, the second type devices 360-361, 460-467, any other part of the network architecture 200, 300, 400, and/or any other computing system described herein.

In some implementations, a computing system 700 can implement the methods described herein, such as to method of disclosure.

The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 700 includes at least one processing unit (CPU or processor) 710 and a connection 705 that couples various system components including system memory 715, such as read-only memory (ROM) 720 and random-access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction, the computing system 700 may include an input device 745, which can represent any number of input mechanisms, such as a microphone for speech, a touch-sensitive screen for gesture or graphical input, keyboard, mouse, motion input, speech, etc. The computing system 700 may also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

1. A method of identifying a point of failure in a first network via a second network, wherein the first network comprises a plurality of first type device, wherein the plurality of first type devices are communicatively connected to a first management system, wherein the second network comprises a plurality of second type devices each communicatively connected to a second management system, and wherein a first device of the first type devices and a second device of the second type devices are located at a same location and communicatively connected via a communication link, and the first management system and the second management system are communicatively connected, the method comprising:
generating, by the first device, a neighbor list comprising an indication of one or more other first type devices that are actively communicatively connected to the first device;
transmitting the neighbor list from the first device to the second device;
transmitting the neighbor list from the second device to the second management system;
transmitting the neighbor list from the second management system to the first management system; and
determining, by the first management system, the point of failure based on the neighbor list.

2. The method according to claim 1, further comprising, prior to generating the neighbor list:
detecting, by the first management system, an offline first type device among the plurality of first type devices;
obtaining, by the first management system, a location of the offline first type device;
transmitting, by the first management system, the location of the offline first type device to the second management system;
determining, by the second management system, the second device based on the location of the offline first type device; and
requesting, by the second management system, the neighbor list from the first device via the second device.

3. The method according to claim 1, further comprising, prior to generating the neighbor list:
detecting, by the first device, a disconnection from the one of the first type devices to trigger the generating of the neighbor list.

4. The method according to claim 1, wherein the determining by the first management system of the point of failure comprises:
comparing the other first type devices indicated in the neighbor list with detected offline first type devices to determine if and which first type devices and/or links between first type devices are the point of failure.

5. The method according to claim 1, wherein the neighbor list comprises one or more of:
an identification of the first device;
an identification of each of the other first type devices;
an indication of a number of active links between the first device and the other first type devices.

6. The method according to claim 1, wherein the second device adds one or more of the following data to the neighbor list:
a message type indicative of being a neighbor list;
geographical location data indicative of said same location.

7. The method according to claim 1, wherein the first device and a second device are parts of one device.

8. The method according to claim 7, wherein the one device is a broadband luminaire device.

9. The method according to claim 1, wherein the first network is a tree structure based data communication network.

10. The method according to claim 1, wherein the second network comprises communicatively connected luminaires.

11. The method according to claim 1, wherein the first management system and the second management system are implemented as cloud services.

12. The method according to claim 1, wherein the point of failure is one or more of: an offline link between two first type devices;
an offline first type device.

13. A device comprising a first device of a first type and a second device of a second type,
wherein the first device is part of a first network, wherein the first device is configured to be communicatively connected to a first management system, and wherein the first device is communicatively connected one or more other first type devices,
wherein the second device is part of a second network and wherein the second device is configured to be communicatively connected to a second management system,
wherein the first device and the second device are communicatively connected via a communication link,
wherein the first device is configured to generate a neighbor list comprising an indication of one or more other first type devices that are actively communicatively connected to the first device, and wherein the first device is configured to transmit the neighbor list to the second device,
and wherein the second device is configured to transmit the neighbor list to the second management system.

14. A system comprising a first network and a second network, wherein the first network comprises a plurality of first type devices, wherein the plurality of first type devices are communicatively connected to a first management system, wherein the second network comprises a plurality of second type devices each communicatively connected to a second management system, and wherein a first device of the first type devices and a second device of the second type devices are located at a same location and communicatively connected via a communication link, and the first management system and the second management system are communicatively connected.
wherein the first device is configured to generate a neighbor list comprising an indication of one or more other first type devices that are actively communicatively connected to the first device,
wherein the first device is configured to transmit the neighbor list to the second device,
wherein the second device is configured to transmit the neighbor list to the second management system,
wherein the second management system is configured to transmit the neighbor list to the first management system,
and wherein the first management system is configured to determine a point of failure in the first network based on the neighbor list.

15. The network according to claim 14, wherein the first communication network is a tree structure based data communication network, and wherein the second communication network comprises communicatively connected luminaires.
